(19) United States
(12) Patent Application Publication
(10) Pub. No.: US 2015/0337571 A1
(43) Pub. Date: Nov. 26, 2015

(54) HANDLE WITH INTEGRATED BIOMETRICS AND VEHICULAR BIOMETRIC DEVICE

(71) Applicant: STRATTEC Advanced Logic, Milwaukee, WI (US)

(72) Inventor: Kevin Henderson, Davenport, FL (US)

(21) Appl. No.: 14/701,083

(22) Filed: Apr. 30, 2015

Related U.S. Application Data
(60) Provisional application No. 61/986,703, filed on Apr. 30, 2014.

(51) Int. Cl. E05B 85/16; G07C 9/00; B60H 1/00; B60R 16/023; E05B 85/24; E05B 81/04

(52) U.S. Cl. CPC E05B 85/16; E05B 85/243; E05B 81/04; B60H 1/00742; B60R 16/023; G07C 9/00158

(57) ABSTRACT

A security system includes a door having a door latch operable between a first position maintaining a closed state and a second position in which movement to an open state is enabled. A door handle on the door is graspable by a human hand to manipulate the door. A biometric scanner in the door handle is configured to detect a biometric parameter of an individual user. A biometric module receives an output of the biometric scanner to identify an authorized individual user. An actuator is operable in response to identification of the authorized individual user to move the door latch from the first position to the second position, or to release a lock which selectively retains the door latch in the first position so that the door is openable by manipulation of the door handle. Biometric scanners and modules for identifying users and triggering retrieval of vehicle settings of the users are also provided.

### CROSS-REFERENCE TO RELATED APPLICATIONS

This application claims priority to U.S. Provisional Patent Application No. 61/986,703, filed Apr. 30, 2014, the entire contents of which are incorporated by reference herein.

### BACKGROUND

Some embodiments of the present invention relate to handles for operating latches which are selectively lockable to prevent operation by the handle. Such handles can be found on the doors of automobiles, for example, to selectively allow or prevent ingress/egress into and out of the vehicle cabin.

Typically, a door handle is operatively coupled to a latch which secures or releases the door with respect to a door frame. A key lock is conventionally provided to lock and unlock the latch. More recently, electronic control of latch locking and unlocking has become common. In many instances, a key fob is provided and operable to transmit a wireless signal to a lock/unlock solenoid within the vehicle door. Some vehicles have also incorporated numeric key pads on the door so that the authorized user may lock and unlock the door by entering an authorized PIN code without requiring any key or key fob.

In addition to using electronic controls for vehicle access, electronic controls are increasingly used in vehicular applications to store and recall one or more settings unique to particular users of the vehicle, such as for recalling and setting seat and mirror positions of the vehicle. While such electronic control of user access and user preference settings represents advancements over conventional vehicle systems, further improvements related to vehicle security, ease of system use, and related functionality are welcome additions to the art.

### SUMMARY

In some embodiments of the present invention, a door handle is provided that has a sensor operable to discern between authorized and unauthorized operators using one or more biometric parameters. The sensor is incorporated into a body of the door handle. The door handle is coupled to a lockable latch mechanism which allows unlatching by operation of the door handle when unlocked, and prevents unlatching by operation of the door handle when locked. The locking state of the latch is controlled by a controller coupled to the sensor. The controller can be incorporated into the body of the door handle. The door handle can be provided on any lockable door (such as a vehicle door), and as part of any security system. The biometric parameter may be used to enable unlatching of the door instead of, or in addition to, alternate mechanisms, such as a key, a wireless key fob and/or a key pad.

In some embodiments, the sensor is a fingerprint scanner. The sensor can be configured to wake up and perform an authentication process in response to a single contact from a user.

Also in some embodiments, the door handle can be movably coupled to a door. Furthermore, the sensor can be positioned on an interior surface of the door handle, facing the door.

In one aspect, the invention provides a security system including a door having a door latch operable between a first position which maintains the door in a closed state and a second position in which movement of the door from the closed state to an open state is enabled. A door handle is provided on the door for grasping by a human hand to manipulate the door between the closed and open states. A biometric scanner in the door handle is configured to detect a biometric parameter of an individual user. A biometric module receives an output of the biometric scanner to identify an authorized individual user based on the output. An actuator is operable in response to identification of the authorized individual user to move the door latch from the first position to the second position, or to release a lock which selectively retains the door latch in the first position so that the door is openable by manipulation of the door handle.

In another aspect, the invention provides a vehicle control system having a controller in communication with at least one vehicle module. A memory is configured to store at least one personal setting of the at least one vehicle module corresponding to an individual pre-selection of an authorized individual user. A biometric sensor is provided on the vehicle and operably coupled to the controller. The biometric sensor is configured to identify the authorized individual user and, in response, the controller is configured to send a signal to the at least one vehicle module to achieve the at least one personal setting of the individual pre-selection.

In yet another aspect, the invention provides a vehicle exterior door handle for selectively opening a vehicle door. The vehicle exterior door handle includes an exterior surface provided for grasping by a hand of a human user. The exterior surface includes an outward-facing surface configured to face the user, and an inward-facing surface configured to face away from the user and toward the vehicle door. A biometric scanner is provided in the door handle along the inward-facing surface. The biometric scanner is configured to detect a biometric parameter of an individual user for identifying an authorized individual user to selectively enable operation of the vehicle exterior door handle.

### BRIEF DESCRIPTION OF THE DRAWINGS

FIG. 1 is a perspective view of a security system including a door having a door handle provided with a biometric scanner.

FIG. 2 is an alternate perspective view of the security system of FIG. 1.

FIG. 3 is a perspective view of a human hand engaging the door handle to interface the security system and open the door.

FIG. 4 is an alternate perspective view of the door handle engaged by a human hand, shown with the door removed to better illustrate a portion of the door handle facing the door.

FIG. 5 is a perspective view of an inward-facing surface of the door handle including a biometric scanner, shown with the door removed to better illustrate the portion of the door handle facing the door.

FIG. 6 is a top view of the door handle.

FIG. 7 is a cross-sectional view of the door and the door handle, taken along line 7-7 of FIG. 1.

FIG. 8 is an exploded assembly view of the door handle.

FIG. 9 is an alternate exploded assembly view of the door handle.

FIG. 10 is an exploded assembly view of a biometric scanner of the security system.

FIG. 11 is an alternate exploded assembly view of the biometric scanner of FIG. 10.

FIG. 12 is a schematic diagram of a vehicle control system according to one aspect of the invention.

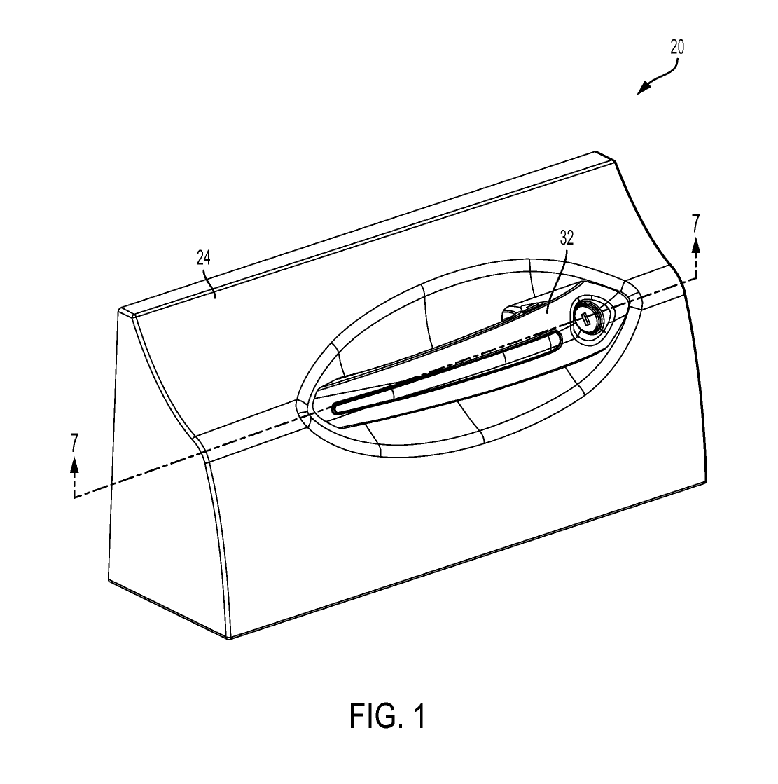

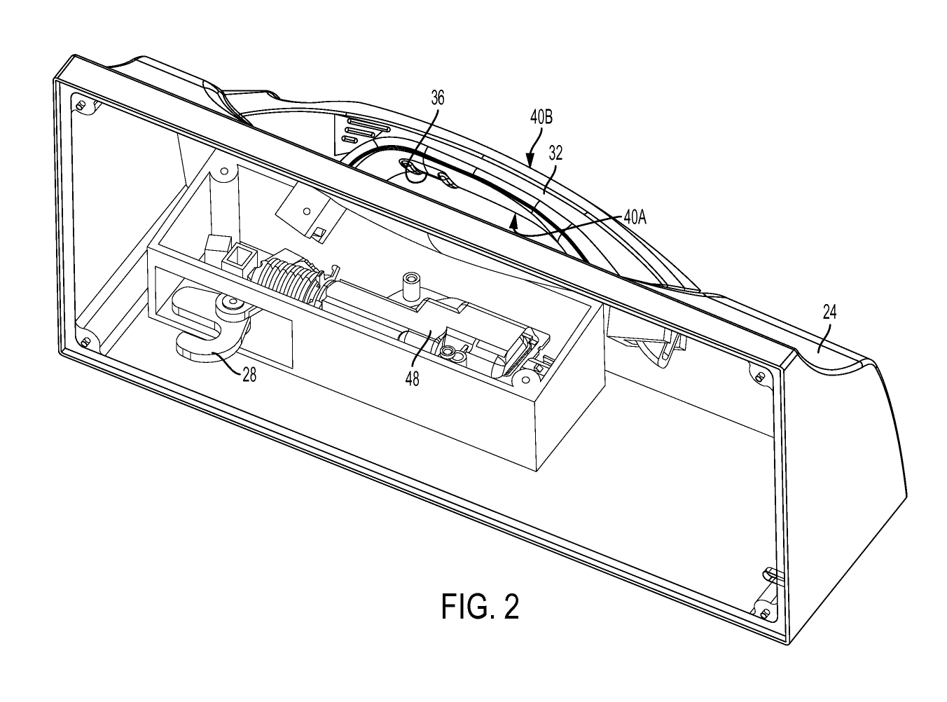

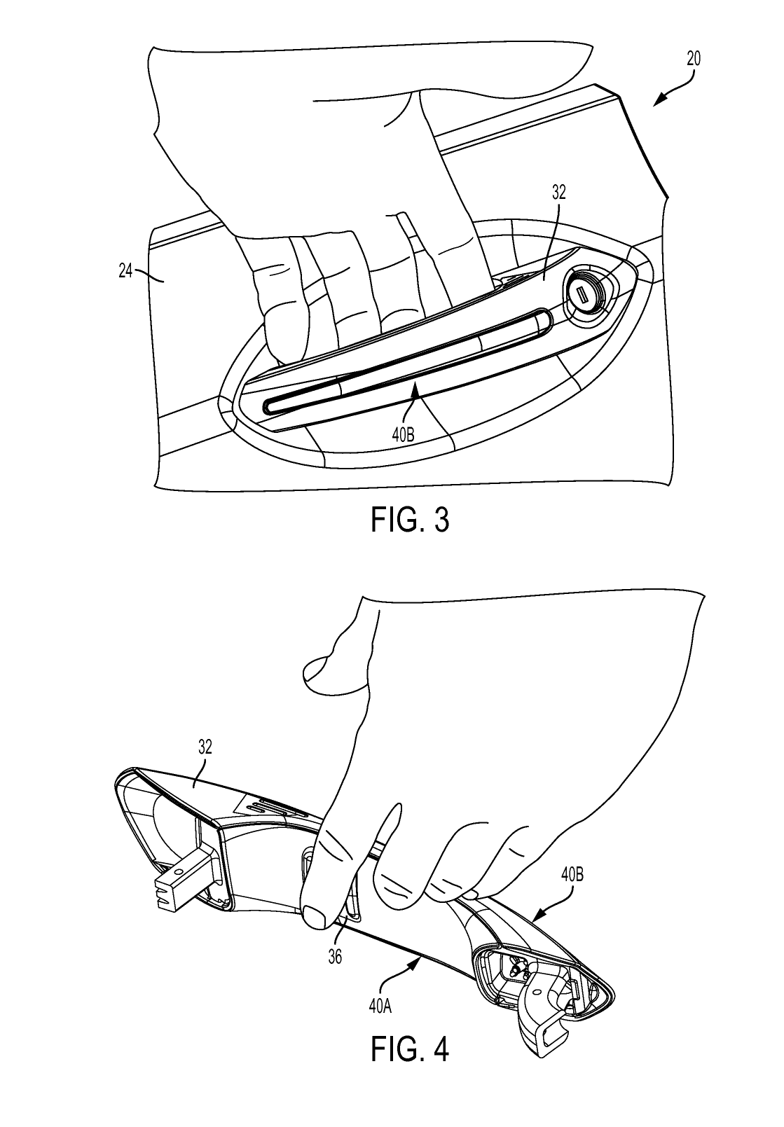

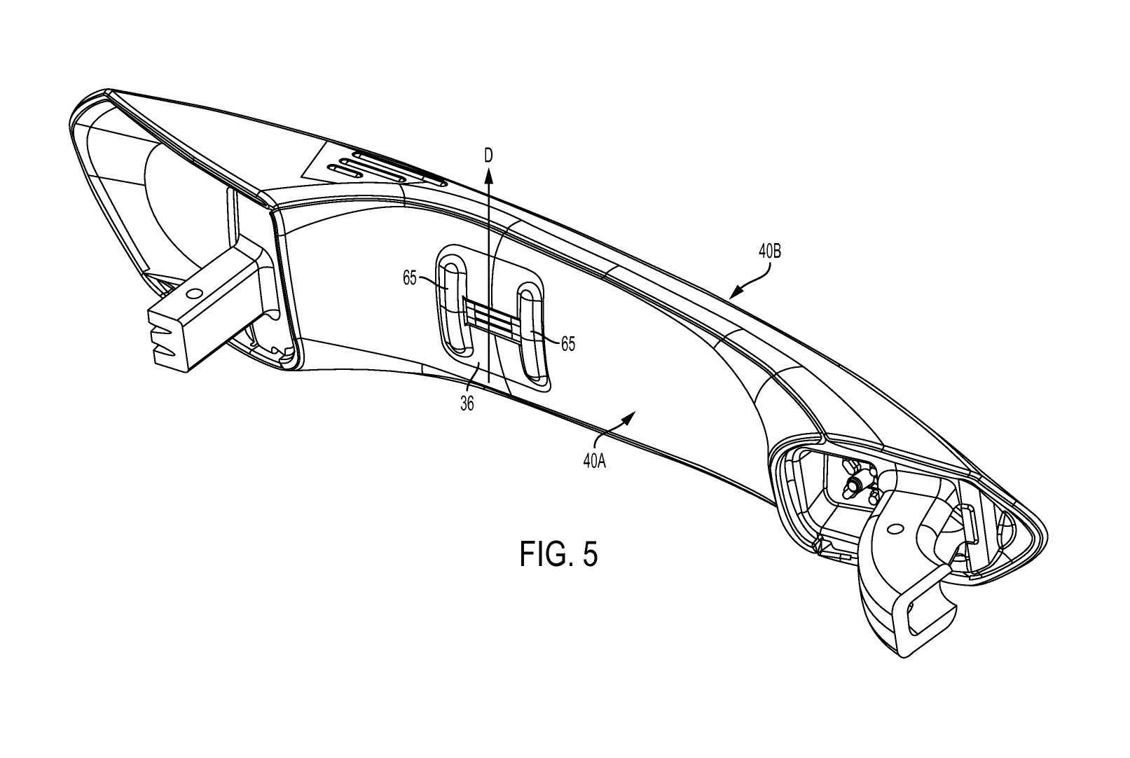

### DETAILED DESCRIPTION

Before embodiments of the present invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

A security system 20 is provided for securing a door 24 relative to a structure including a door frame. The door 24 can be a vehicle door as illustrated, and the structure can be the body of the vehicle to which the door 24 is coupled, the body including a door frame. A door latch 28 between the door 24 and the structure can be selectively latched and unlatched, and may further be locked to prevent unlatching and unlocked to allow unlatching. The door 24 is provided with a door handle 32. The door handle 32 is designed with a shape to be grasped by a human hand for manipulation of the door handle 32 and/or the door 24. The door handle 32 can be movably mounted on the door 24 (e.g., to slide, shift, swing, or pivot) for releasing the door latch 28 when the door 24 is unlocked. In other constructions, the door handle 32 may be fixed relative to the door 24 and an alternate means (e.g., an electric motor or solenoid) provided to release the door latch 28.

As discussed further below, the door handle 32 of the illustrated embodiment enables easy access to vehicles or other restricted areas or compartments without keys (which are subject to loss) and without codes (which are subject to being forgotten). This provides a low-cost security system 20 that combines industry leading security with improved user convenience.

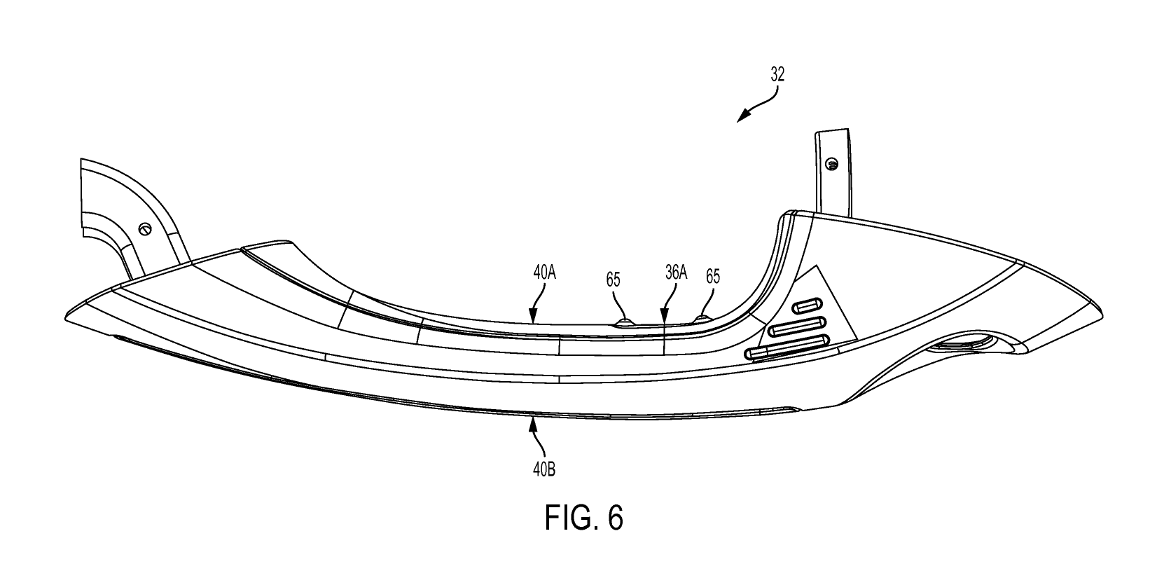

A biometric scanner 36 is provided on the door 24. For example, the biometric scanner 36 can be provided in the door handle 32. More particularly, the biometric scanner 36 can be positioned along an inward-facing surface 40A of the door handle 32 that faces the door 24. The inward-facing surface 40A is opposite an outward-facing surface 40B that faces away from the door 24. In some constructions, the biometric scanner 36 has an exterior surface (e.g., touch surface) 36A arranged flush with the inward-facing surface 40A of the door handle 32 (FIG. 6). However, in other constructions, the biometric scanner 36 can be positioned along other surfaces of the door handle 32, such as the outward-facing surface 40B, an upward-facing surface, a downward-facing surface, a side surface, etc. In any such construction, the exterior surface 36A of the biometric scanner 36 can optionally be arranged flush with the directly surrounding exterior surface of the door handle 32. When located on the inward-facing surface 40A of the door handle 32 as shown in the accompanying figures, the biometric scanner 36 has an extra level of protection against the environment (e.g., snow, ice, direct sunlight, and the like), and the outward aesthetics of the door handle 32 are not affected by the biometric scanner 36.

The biometric scanner 36 is configured to detect a biometric parameter of an individual user. In some constructions, the biometric scanner 36 is a fingerprint reader and the biometric parameter is a user's unique fingerprint. A biometric module 44 is provided in communication with the biometric scanner 36 and is configured to receive an output of the biometric scanner 36. Based on the output, the biometric module 44 identifies an authorized individual user. Once authorized, the biometric module 44 communicates with an actuator 48 (e.g., electric motor, solenoid, etc.) to move the door latch 28 from the latched position to the unlatched position, or to release a lock which selectively retains the door latch 28 in the latched position so that the door 24 is openable by manipulation of the door handle 32. As mentioned above, the door handle 32 can be a user-actuated, movable handle. However, in a construction where the door handle 32 is stationary (fixed relative to the door 24), signals from the biometric scanner 36 and/or any other sensor of the door handle 32 can trigger the door latch 28 to be unlocked and/or released.

In addition to locating the biometric scanner 36 in the door handle 32 as just described, in some embodiments the biometric scanner 36 is mounted to a printed circuit board (PCB) 54 that is also located within the door handle 32 as described above. The PCB 54 provided with the biometric scanner 36 can be part of the biometric module PCB or a separate biometric module PCB can be provided. For example, the PCB 54 can be the same board carrying other electrical components of the security system, including a controller/processor, a battery, an antenna, and the like. Thus, additional functions such as the storing of data and user profiles, power supply, and/or communications (for example) can be provided by the hardware located on the PCB 54 with the biometric scanner 36 directly within the door handle 32. As another example, the PCB 54 provided with the biometric scanner 36 can be a separate board that is either mounted on a biometric module PCB within the interior of the door handle 32 (e.g., on the reverse side of a biometric module PCB as described above) or that is in communication with a biometric module PCB and/or a battery or power supply via one or more wires extending from the biometric scanner 36 or PCB 54 along a length of the door handle 32 to a position within a base of the door handle and/or an interior of the door 24 where the separate biometric module PCB and/or battery is mounted.

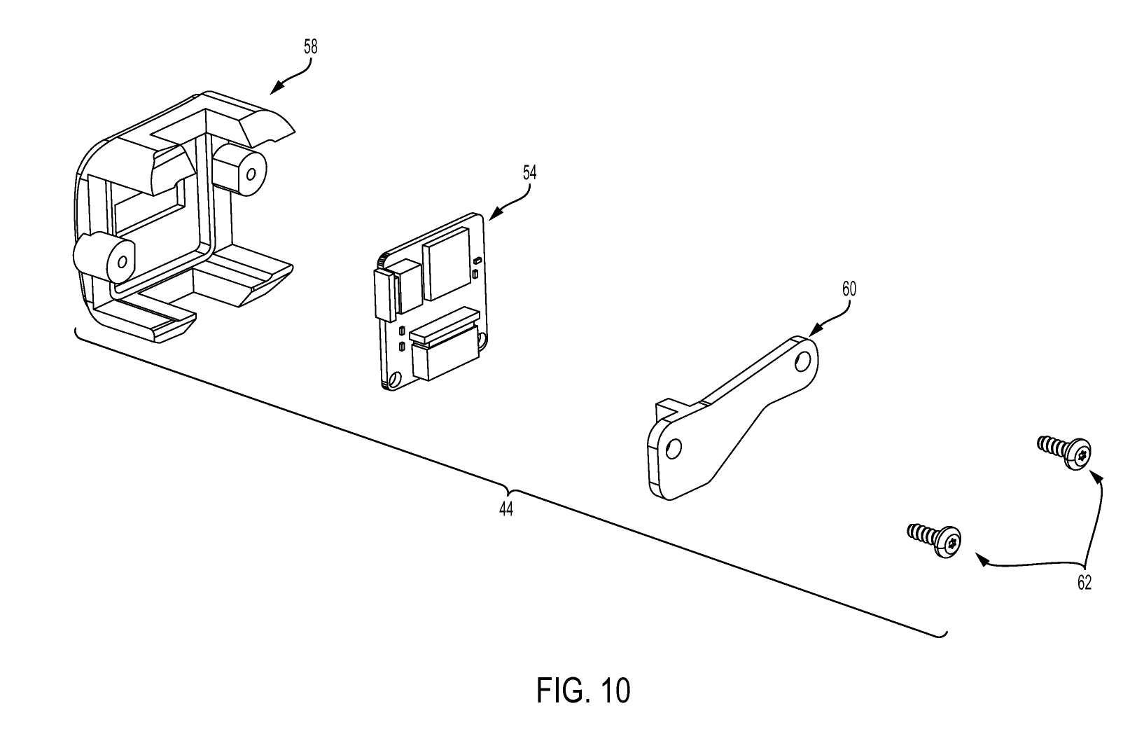

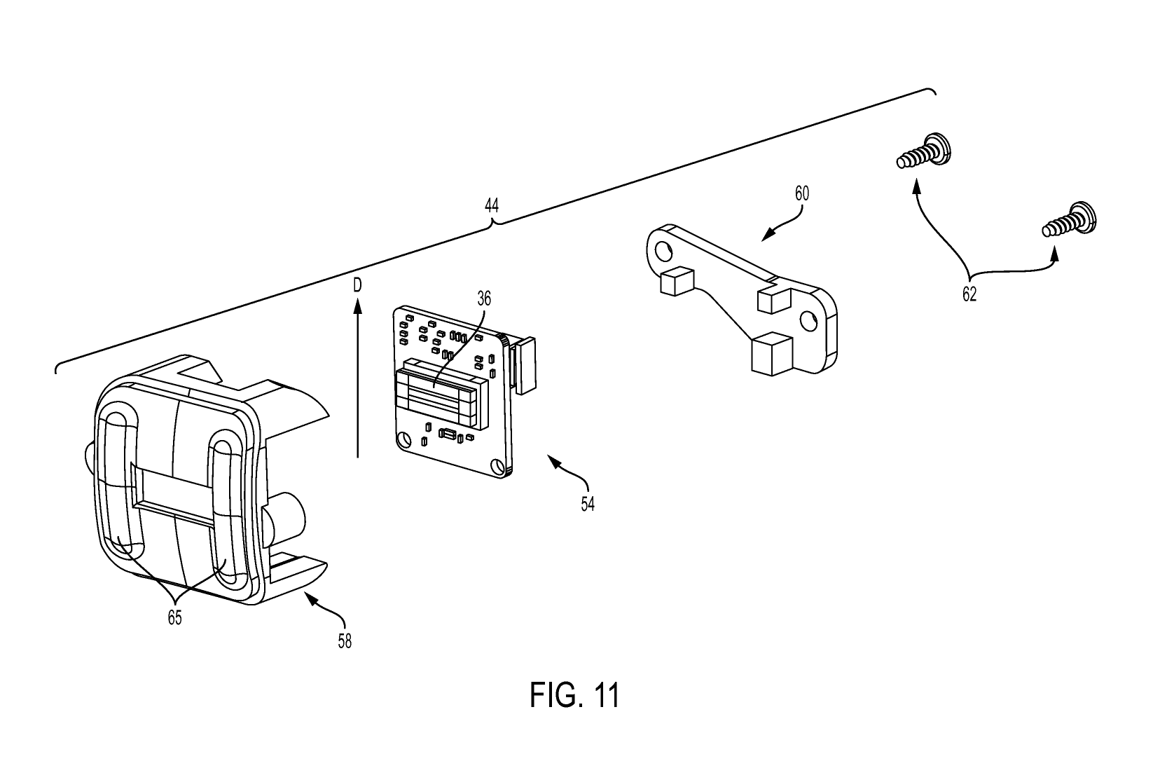

As shown in FIGS. 10 and 11, the biometrics module 44 is provided with a single PCB 54 including the biometric scanner 36 along with a front housing or cover 58. The cover 58 covers the PCB 54, but leaves the exterior surface 36A of the biometric scanner 36 exposed for use. A fixture or bracket 60 is provided to secure the PCB 54 relative to the cover 58. For example, the PCB 54 can be clamped between the bracket 60 and the cover 58 and held with fasteners 62 (e.g., screws). As shown in FIG. 11 and elsewhere, the cover 58 can be provided with one or more (e.g., two) tactile features 65 such as raised ribs, humps, or other projections, grooves, recesses, or other apertures located directly adjacent the biometric scanner 36. The tactile features 65 can define a guideway for a user to tactilely detect where to swipe their finger across the biometric scanner 36. Thus, the tactile features 65 can be elongated parallel to a swiping direction D defined by the biometric scanner 36 (parallel to a minor dimension of the biometric scanner 36).

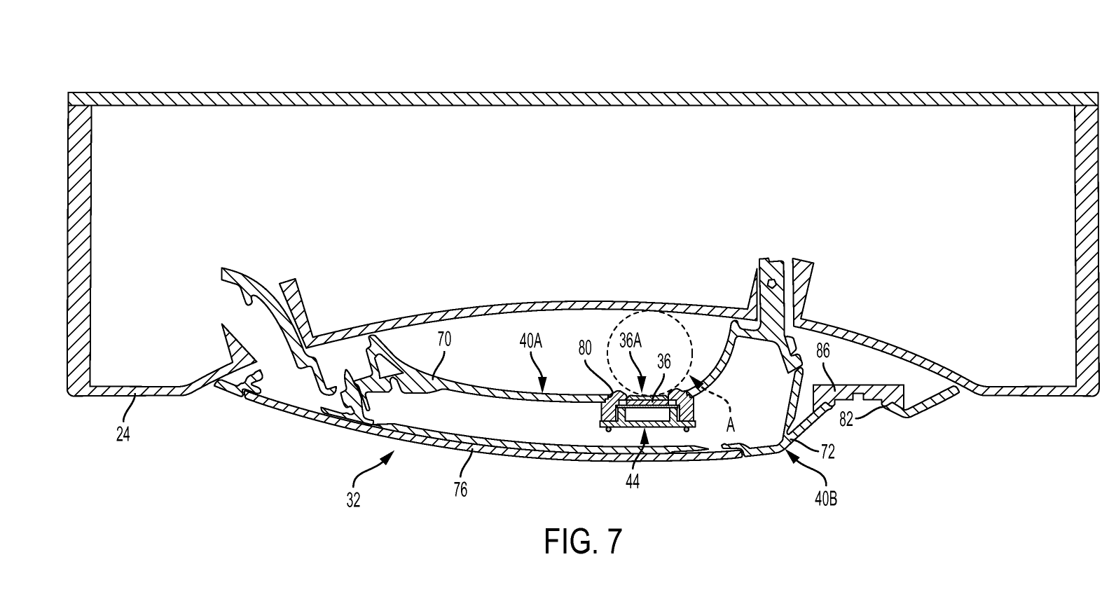

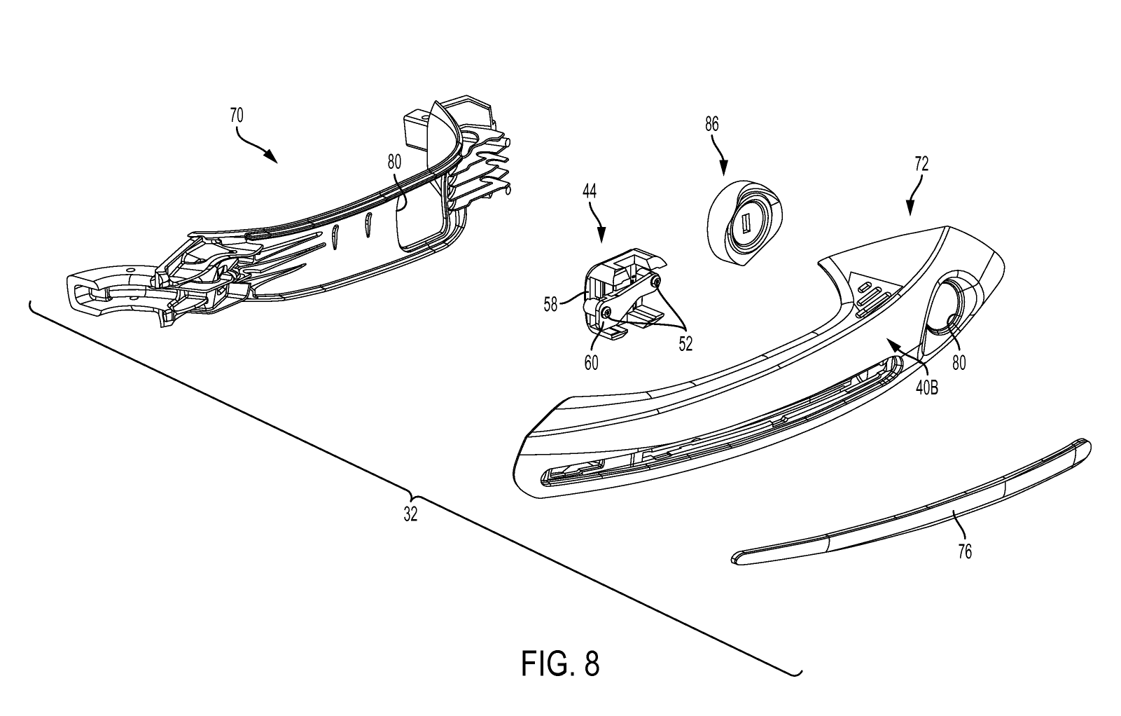

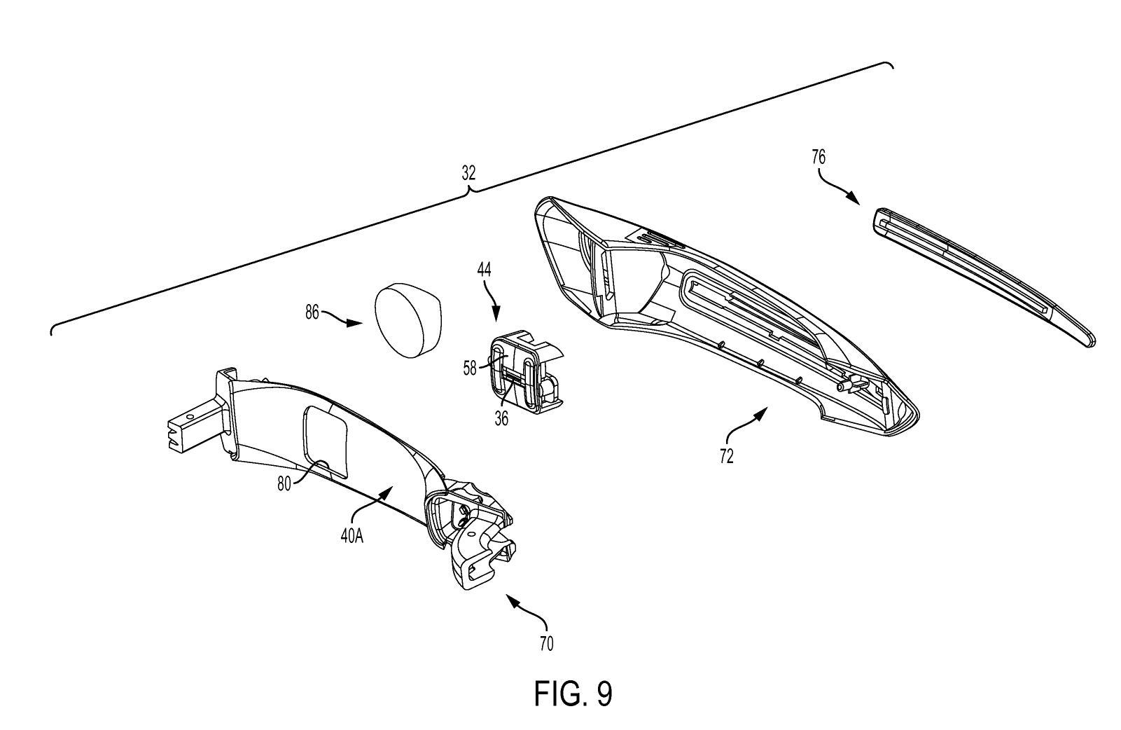

As shown in FIGS. 7-9, the biometric scanner 36 can be mounted in a recess or opening 80 within the door handle 32, whereby the PCB 54 of the biometric scanner 36 and/or biometric module 44 (depending upon configuration as described above) can be located in an interior closed space within the door handle 32 at a location along the length of the handle. In such embodiments, suitable wiring can extend from the PCB 54 of the biometric scanner 36 and/or biometric module 44 to a location in a base of the door handle 32 and/or where the wiring exits the door handle 32 and enters the door 24 (e.g., through an aperture) for communication with the door latch 28 or other controllers within the vehicle. Also in such embodiments, a battery powering the security system can be electrically connected to the biometric scanner 36 and/or PCB(s), and can be located within an interior closed space within the door handle 32. As an alternative to wiring extending along the door handle 32 and to a location within the door 24 or in a base of the door handle 32 as described above, the PCB 54 of the biometric scanner 36 and/or biometric module 44 can be provided with a wireless transmitter of any suitable type for communication with a controller inside the door 24 or a controller of the vehicle in order to operate the latch 28 responsive to user authentication via the biometric scanner 36.

In some embodiments, the biometric module 44 of the present invention is engineered to fit into very small spaces having a wide variety of shapes. For example, a biometric module 44 board may be only 31.2 mm wide by 58.6 mm long and 11.3 mm thick, and so can provide an external fingerprint sensor board (e.g., 20 mm×20 mm and is 10.6 mm thick) that can be mounted into the very small area defined by the interior of the door handle 32. If an external sensor PCB is not provided, the biometric scanner 36 can be mounted on the reverse side of the biometrics module board, in which case both can again be received within the interior of the door handle 32. This allows biometric, PIN code and other authentication devices to be placed into a product, such as a door handle, that otherwise would not be possible due to size restrictions.

Although not necessarily limited to any single type of door handle, FIGS. 7-9 provide additional details of the door handle 32 of the illustrated construction for a vehicle door handle. The door handle 32 includes a first (e.g., inner) shell 70 and a second (e.g., outer) shell 72. The shells 70, 72 can be secured together in any suitable manner (e.g., snap fit, fasteners, adhesive, and combinations thereof) and when secured, define an interior space housing at least the biometric scanner 36, and optionally the biometric module 44 with all its associated electronics. As shown, the outer shell 72 can receive a decorative (e.g. chrome) accent strip 76 along the outward-facing surface 40B. The inner shell 70 is provided with the opening 80 in which the biometric scanner 36 (and optionally a portion of the biometric module 44) is positioned when assembled. As shown in FIG. 7, an operational area A directly in front of the biometric sensor 36 has a diameter of at least 25 mm (from the surface 36A to the door 24) when the door handle 32 is not actuated. The operational area A is free of obstruction from any components of the door 24 or the door handle 32 to ensure space for a typical human hand to enter and interact with the biometric scanner 36. In some constructions the diameter of the operational area A is 28.3 mm. The outer shell 72 is optionally provided with an aperture 82 configured to receive a key cylinder. As illustrated, a key cylinder plug 86 is provided to fill the aperture 82. The key cylinder plug 86 can be used temporarily during intermediate manufacturing and/or transit, until such time that a keyed key cylinder is provided for final customer use. In other constructions, the door handle 32 is not provided with any key cylinder or plug.

The biometric module 44 of the security system 20 can store biometric authorization parameters for multiple users. For example, the system can be configured to store up to 5 users in some constructions. The biometric scanner 36 provides a signal to the biometric module 44 which determines whether there is a match with any of the authorized users in a very short amount of time (e.g., less than 0.07 seconds). In some embodiments, the security system 20 can scale up to 40 users as required. The security system 20 including the biometric scanner 36 is compatible with existing door handle styling and design, and is not limited to the particular style, shape, size, etc. of the illustrated door handle 32. In further embodiments, the biometric scanner 36 can be combined with a weatherproof LCD screen offering further user flexibility. Such a screen can be incorporated into the door handle 32 (in the outward-facing surface 40B of the door handle 32 facing away from the door 24), or can be provided on the door 24 adjacent the handle 32. In some constructions, the biometric scanner 36 is waterproof.

The biometric module 44 can enable new authorized users to be added quickly. The biometric module 44, including the biometric scanner 36, can withstand up to 30 KV static discharge on the sensor, and can operate in a wide range of ambient temperatures (e.g., −30 Celsius to +70 Celsius).

In some embodiments, the biometric module electronics are completely stand-alone, such that all the required system electronics can be or are positioned within the door handle 32.

In some constructions in which the biometric scanner 36 is a fingerprint reader for example, the biometric module 44 can:

read a finger swipe speed up to 40 cm/s;

accommodate variable swiping speed in real time;

automatically correct for off-angle swipes (e.g., up to 15 degrees); and/or

be certified for 20 million rubs (e.g., the fingerprint sensor can includes a 6-H hardness coating to reduce scratches).

In some embodiments, the biometric module 44 includes a configuration system that uses a text file generated from a personal computer (PC) to control the functions of the product. The biometric module 44 can be designed so that all internal functions that are ‘variable’ in nature get their function from the configuration file. The biometrics module configuration system is far faster than conventional configuration systems. Normally, for an embedded device, these functions are performed through a firmware upgrade. This requires a programmer having access to the source code to make appropriate changes to the product and to compile (and often test extensively for errors) a new version of the binaries. These binaries are then flashed into the end product. With the biometric module 44 of the present invention, all the options for functions are exposed in menu-driven software on the manufacturer's or user's PC. The PC then creates a simple text file that is transferred to the product via USB, serial connection, or in any other suitable manner. This method requires no programmer, no programming, no dangerous flashing process (e.g., the danger of ruining a product if a flash process being performed on a product is interrupted), and can be performed with limited or minimal skills. The system allows the manufacturer to experiment with functionality in almost real time with no risk on the actual manufactured product.

For example, in an application where a manufacturer is developing a door lock that drives a motor to open a latch after a user is authenticated, a parameter for motor operation is how far the motor drives the latch in one or more directions. In such an application, the motor may not drive the latch a sufficient distance for a latching or unlatching operation, and/or may drive the latch too far for such an operation. To solve this problem, a manufacturer can generate a new configuration file for the system that sets new values for a parameter corresponding to the amount of movement of the latch (e.g., the amount the motor is driven after a user is authenticated). Accordingly, a manufacturer can address product deficiencies or changes quickly and easily using the configuration text file. Similarly, if a user desires that the product allows for 50 different users rather than 5 different users as the product is currently configured, a manufacturer can generate a new configuration file that increases the maximum number of users. As another example, if a user desires to use a personal identification number (“PIN”) for identification rather than biometrics (e.g., a fingerprint scanner), a manufacturer can generate a new configuration file that looks solely to a keypad for authentication, and ignores any biometrics. As yet another example, a manufacturer can generate a new configuration file as described above to change a display (e.g., add a company's logo, change menu options, orders, etc.). Accordingly, in some embodiments, a manufacturer can quickly make these changes without forcing the manufacturer to perform any programming, binary file creation, or flashing.

In some embodiments, the biometric module 44 can operate for long periods of time on battery power. For example, four AA batteries on average can power authentication via the biometric module 44 for a device for 274 days of operation (used 5 times per day). The device can have a special circuit that has various levels of sleep that are activated. In effect, the longer the device goes unused, the deeper the sleep it enters. ‘Start-up time’ (described in detail below) is improved so that even from the deepest sleep mode, the length of time to power-up and authenticate a user is hardly noticeable (even not noticeable at all) by most users. The wake up from sleep mode and authentication can occur with a single motion, actuation, or swipe.

The low power capabilities of the biometric module 44 enable long term battery operation and battery backup capabilities. Products that receive hard wired power get new capabilities as well such as extraordinarily long term battery backup (in effect, an integrated real-time uninterrupted power supply (UPS)) providing continuous operation even when power is interrupted.

In some embodiments, the security system 20 uses POE (power over Ethernet) to recharge a battery (e.g., lithium battery) when the POE is supplying power to the system, whereas when power is interrupted the system continues operation completely uninterrupted and in some applications can operate for up to 6 months with no directly supplied power. In some applications, the battery-based system of the present invention allows the user to unlock a vehicle door electronically in the event the primary vehicle battery is dead. Still other applications include devices that require authentication capabilities (e.g., a safe or a cabinet) but in which cases it is undesirable to require the user to plug in the system or to replace batteries frequently.

In some embodiments, the security system 20 of the present invention provides one or more energy-savings or “sleep modes” that are automatically entered when one or more sufficient predetermined time periods pass. In such embodiments, this circuit can control how quickly the biometric module 44 can ‘wake-up’ from a sleep state. A rapid “wake-up” process allows the door latch 28 and/or lock to be available to the user for use at all times to have a very long battery life. This is ideal for a door where the user may use the door lock frequently (e.g., every day), or might use the door lock only occasionally (e.g., once per month). Many door latches and locks that use battery operation benefit from such a feature, which provides fast operation if used often or rarely, but does not require the user to constantly replace batteries.

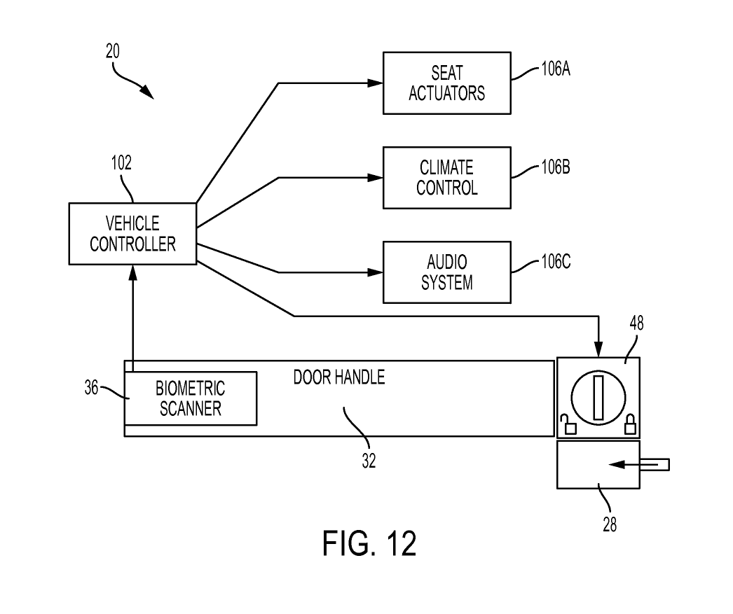

FIG. 12 illustrates a control system for a vehicle according to another aspect of the invention. The control system can be provided as an extension of the security system 20 described above, or as a standalone system. As such, the control system may provide any or all the functionality related to unlocking and/or unlatching a vehicle door 24 as described above in detail. However, the control system can instead or in addition provide other functionality associated with the biometric scanner 36 and the biometric module 44. In particular, the control system allows for customization of one or more setting within a vehicle according to settings predefined for an individual authorized user.

The control system includes a vehicle controller 102 in communication with the biometric scanner 36 and at least one vehicle module 106A-C. The controller 102 can be the controller of the biometric module 44 or a separate controller within the vehicle. The controller 102 is operable to vary at least one setting or parameter for each vehicle module 106A-C by sending a corresponding control signal. A memory is configured to store at least one personal setting of the vehicle module(s) 106A-C corresponding to an individual pre-selection of an authorized individual user, and multiple user profiles may be stored in the memory. The biometric scanner 36 is configured to identify the authorized individual user and, in response, the controller 102 is configured to send a signal to the vehicle module(s) 106A-C to achieve the at least one personal setting of the individual pre-selection. As illustrated, the vehicle modules include seat actuators 106A, a climate control system 106B, and an audio system 106C, although the system may also be functional with any number of additional modules (e.g., vehicle side-view mirrors, rear-view mirrors, accent and other lighting, engine, transmission, and/or suspension performance settings, and the like) not limited to the interior compartment. Although the biometric scanner 36 used to retrieve such user settings (and adjust vehicle components and systems accordingly) can be located in a handle 32 of the vehicle as described above, it should be noted that in such embodiments the biometric scanner can be located elsewhere within on the exterior of the vehicle. By way of example only, the biometric scanner 36 can be located on a dashboard of the vehicle, on an overhead console, on a console located between seats of the vehicle, on a vehicle seat (e.g., front or side of a seat base), on a vehicle visor, on an interior door panel or door handle of the vehicle, on any portion of a vehicle steering wheel or steering column, and the like.

In the case of the seat actuators 106A, these are used to configure the seat (e.g., driver's seat) into a configuration preferred by the identified authorized user. For example, the seat actuators can control one or more of the seat fore-aft position, vertical height, seat back incline angle, lumbar support, heating/cooling, etc. In the case of the climate control system 106B, one or more of a temperature setting, HVAC mode, fan speed, etc. may be set according to a configuration preferred by the identified authorized user. In the case of the audio system, one or more of an input source, graphic equalization, volume setting, etc. may be set according to a configuration preferred by the identified authorized user. In the case of vehicle mirrors, the orientations of the mirrors (and in some cases, the retraction and deployment of the mirrors) may be set according to a configuration preferred by the identified authorized user. In the case of accent and other lighting, the particular lights, color, and/or brightness of interior vehicle lights, and/or the vehicle headlight angle can be set according to a configuration preferred by the identified authorized user. In the case of engine, transmission, and/or suspension performance settings, engine power, transmission shift characteristics, and tunable suspension stiffness are examples of vehicle settings that can configured and recalled by use of the biometric scanner 36 as discussed above.

What is claimed is:

1. A security system comprising:
a door having a door latch, the door latch being operable between a first position which maintains the door in a closed state and a second position in which movement of the door from the closed state to an open state is enabled;
a door handle provided on the door for grasping by a human hand to manipulate the door between the closed and open states;
a biometric scanner provided in the door handle and configured to detect a biometric parameter of an individual user;
a biometric module configured to receive an output of the biometric scanner, and identify an authorized individual user based at least in part on the output; and
an actuator operable in response to identification of the authorized individual user to move the door latch from the first position to the second position, or to release a lock which selectively retains the door latch in the first position so that the door is openable by manipulation of the door handle.

2. The security system of claim 1, wherein the biometric module is provided in the door handle.

3. The security system of claim 1, wherein the door handle includes an outward-facing surface, facing away from the door and an inward-facing surface, facing the door, and wherein the biometric scanner is positioned along the inward-facing surface.

4. The security system of claim 3, wherein the biometric scanner has an exterior surface arranged flush with the inward-facing surface of the door handle.

5. The security system of claim 1, wherein the biometric sensor is a fingerprint reader.

6. The security system of claim 1, wherein the door is a vehicle door and the door handle is a vehicle door handle.

7. The security system of claim 6, further comprising
a controller in communication with the biometric scanner and at least one vehicle module; and
a memory configured to store at least one personal setting of the at least one vehicle module corresponding to an individual pre-selection of an authorized individual user;
wherein the biometric scanner is configured to identify the authorized individual user and, in response, the controller is configured to send a signal to the at least one vehicle module to achieve the at least one personal setting of the individual pre-selection, and
wherein the personal setting includes one or more of
an audio system setting,
a climate control system setting, and
a driver's seat setting.

8. The security system of claim 1, wherein the door handle is movable relative to the door between a first position and a second position for releasing the door latch from the first position to the second position.

9. The security system of claim 1, wherein the biometric module stores biometric authorization profiles for a plurality of authorized individual users.

10. The security system of claim 1, wherein the biometric module includes a configuration system that uses a text file generated from a PC to vary at least one parameter of the security system.

11. A vehicle control system comprising:
a controller in communication with at least one vehicle module;
a memory configured to store at least one personal setting of the at least one vehicle module corresponding to an individual pre-selection of an authorized individual user; and
a biometric sensor provided on the vehicle and operably coupled to the controller,
wherein the biometric sensor is configured to identify the authorized individual user and, in response, the controller is configured to send a signal to the at least one vehicle module to achieve the at least one personal setting of the individual pre-selection.

12. The vehicle control system of claim 11, wherein the at least one vehicle module is selected from the group consisting of: an audio system, a climate control system, and a seat positioning system.

13. The vehicle control system of claim 11, wherein the at least one vehicle module includes an audio system, a climate control system, and a seat positioning system.

14. The vehicle control system of claim 11, wherein the personal setting includes an audio input source and/or audio volume setting of an audio system within the vehicle.

15. The vehicle control system of claim 11, wherein the personal setting includes a temperature and/or fan speed of a climate control system of the vehicle.

16. The vehicle control system of claim 11, wherein the personal setting includes a seat back recline angle, a fore-aft seat position within the vehicle, and a vertical seat position within the vehicle.

17. The vehicle control system of claim 11, further comprising a vehicle door having a door handle for grasping by a human hand to manipulate the door between closed and open states, wherein the biometric sensor is provided on the door.

18. The vehicle control system of claim 17, further comprising an actuator operable in response to identification of the authorized individual user to unlock a door latch of the vehicle door and/or release the door latch so that the door is openable with the door handle.

19. The vehicle control system of claim 17, wherein the biometric sensor is provided on the door handle.

20. The vehicle control system of claim 19, wherein the biometric sensor is a fingerprint reader and the fingerprint reader is positioned along an inward-facing surface of the door handle, facing the door.

21. A vehicle exterior door handle for selectively opening a vehicle door, the vehicle exterior door handle comprising:
an exterior surface provided for grasping by a hand of a human user, the exterior surface including an outward-facing surface configured to face the user, and an inward-facing surface configured to face away from the user and toward the vehicle door; and
a biometric scanner provided in the door handle along the inward-facing surface, the biometric scanner configured to detect a biometric parameter of an individual user for identifying an authorized individual user to selectively enable operation of the vehicle exterior door handle.
